(19) United States
(12) Patent Application Publication
(10) Pub. No.: US 2025/0150353 A1
(43) Pub. Date: May 8, 2025

(54) SYSTEM AND METHOD FOR ANOMALY DETECTION IN A DISTRIBUTED CLOUD ENVIRONMENT

(71) Applicant: Aviatrix Systems, Inc., Santa Clara, CA (US)

(72) Inventors: Jacob Cherkas, Santa Clara, CA (US); Arno Lenin Malyala, Santa Clara, CA (US); Bryan Ashley, Santa Clara, CA (US)

(73) Assignee: Aviatrix Systems, Inc., Santa Clara, CA (US)

(21) Appl. No.: 18/836,923

(22) PCT Filed: Feb. 8, 2023
(86) PCT No.: PCT/US2023/012584

§ 371 Date: Aug. 8, 2024

Related U.S. Application Data
(60) Provisional application No. 63/308,038, filed on Feb. 8, 2022.
(60) Provisional application No. 63/320,019, filed on Mar. 15, 2022.

(51) Int. Cl. H04L 41/142; H04L 12/46; H04L 41/0681; H04L 41/069; H04L 41/0806; H04L 41/16

(52) U.S. Cl. CPC H04L 41/142; H04L 12/4641; H04L 41/0681; H04L 41/069; H04L 41/0806; H04L 41/16

(57) ABSTRACT

A distributed cloud computing system further includes logic, stored on non-transitory, computer-medium, that, upon execution by one or more processors, causes performance of operations including generating a first fingerprint for the first VPC being a statistical measure of a plurality of network metrics during a learning phase, generating a second fingerprint for the second VPC being a statistical measure of the plurality of network metrics during the learning phase, receiving, from the controller, metadata pertaining to each of the first gateway and the second gateway, receiving, from each of the first gateway and the second gateway, network data, wherein the metadata and the network data identify each of the plurality of constructs, the communication paths between each construct, and in which cloud computing network each construct is deployed, detecting an anomaly in one or more network traffic metrics of either the first VPC or the second VPC based on a comparison of received network traffic and a corresponding fingerprint, and generating an alert that the anomaly was detected.

### CROSS-REFERENCE TO RELATED APPLICATIONS

This application claims priority to, and incorporates by reference the entire disclosures of, U.S. Provisional Patent Application No. 63/308,038, filed on Feb. 8, 2022, and U.S. Provisional Patent Application No. 63/320,019, filed on Mar. 15, 2022.

### FIELD

Embodiments of the disclosure relate to the field of network behavior analytics and for resources deployed in one or more cloud computing environments. More specifically, embodiments of the disclosure relate to a method for generating a baseline of network behavior for a particular virtual private cloud over a learning period, the baseline encompassing a plurality of metrics, and subsequently analyzing real-time network traffic in light of the baseline to detect the presence of anomalous behavior.

### BACKGROUND

This section provides background information to facilitate a better understanding of the various aspects of the disclosure. It should be understood that the statements in this section of this document are to be read in this light, and not as admissions of prior art.

Until recently, businesses have relied on application software installed on one or more electronic devices residing in close proximity to its user (hereinafter, “on-premises electronic devices”). These on-premises electronic devices may correspond to an endpoint device (e.g., personal computer, cellular smartphone, netbook, etc.), a locally maintained mainframe, or even a local server for example. Depending on the size of the business, the purchase of the on-premises electronic devices and their corresponding software required a significant upfront capital outlay, along with significant ongoing operational costs to maintain the operability of these on-premises electronic devices. These operational costs may include the costs for deploying, managing, maintaining, upgrading, repairing and replacing these electronic devices.

Recently, more businesses and individuals have begun to rely on public cloud networks (hereinafter, “public cloud”) for providing users to a variety of services, from word processing application functionality to network management. A “public cloud” is a fully virtualized environment with a multi-tenant architecture that provides tenants (i.e., users) with an ability to share computing and storage resources while, at the same time, retaining data isolation within each user's cloud account. The virtualized environment includes on-demand, cloud computing platforms that are provided by a collection of physical data centers, where each data center includes numerous servers hosted by the cloud provider. Examples of different types of public cloud networks may include, but is not limited or restricted to AMAZON WEB SERVICES®, MICROSOFT® AZURE®, GOOGLE CLOUD PLATFORM™ or ORACLE CLOUD™ for example.

This growing reliance on public cloud networks is due, in large part, to a number of cost saving advantages offered by this particular deployment. However, for many type of services, such as network management for example, network administrators face a number of challenges when business operations rely on operability of a single public cloud or operability of multiple public cloud networks. For instance, where the network deployed by an enterprise relies on multiple public cloud networks (hereinafter, “multi-cloud network”), network administrators have been unable to effectively troubleshoot connectivity issues that occur within the multi-cloud network. One reason for such ineffective troubleshooting is there are no conventional solutions available to administrators or users to visualize connectivity of its multi-cloud network deployment. Another reason is that cloud network providers permit the user with access to only a limited number of constructs, thereby controlling the type and amount of network information accessible by the user. As a result, the type or amount of network information is rarely sufficient to enable an administrator or user to quickly and effectively troubleshoot and correct network connectivity issues.

Likewise, there are no conventional solutions to visually monitor the exchange of traffic between network devices in different public cloud networks (multi-cloud network) and retain state information associated with network devices with the multi-cloud network to more quickly detect operational abnormalities that may suggest a cyberattack is in process or the health of the multi-cloud network is compromised.

### SUMMARY

In various embodiments, aspects of the disclosure relate to distributed cloud computing system comprising: a controller configured to deploy a first virtual private cloud (VPC) in a first cloud computing network, a first gateway in the first VPC, a second VPC in a second cloud computing network, and a second gateway in the second VPC, and wherein a first subset of a plurality of constructs are associated with the first gateway and deployed in the first cloud computing network, and a second subset of the plurality of constructs are associated with the second gateway and deployed in the second cloud computing network; and logic, stored on non-transitory, computer-medium, that, upon execution by one or more processors, causes performance of a variety of operation.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is a diagram of an exemplary embodiment of a distributed cloud computing system including a controller managing constructs spanning multiple cloud networks according to some embodiments;

FIG. 2A is an exemplary illustration of a logical representation of a controller deployed within a cloud computing platform in accordance with some embodiments;

FIG. 2B is an exemplary illustration of a logical representation of the topology system logic deployed within a cloud computing platform in accordance with some embodiments;

FIGS. 3A-3C are interface screens displaying portions of a dashboard of a visualization platform directed to illustrating information pertaining to network traffic and constructs within a cloud-computing environment according to some embodiments;

FIG. 4A is an interface screen displaying portions of a dashboard of the visualization platform with each portion configured to illustrate information obtained or determined by the topology system according to some embodiments;

FIG. 4B is an interface screen displaying portions including detailed information of the threats discussed with respect to FIG. 4A according to some embodiments;

FIG. 4C is an interface screens displaying a network topology map illustrating a compromised gateway in a highlighted capacity according to some embodiments;

FIG. 5A is a graphical representation of functionalities associate with a broader security platform according to some embodiments;

FIG. 5B is an interface displaying of results of an analysis involving network behavior analytics according to some embodiments;

FIG. 6A is a graphical representation of interface screens displaying portions of a dashboard of a visualization platform directed to illustrating information pertaining to anomaly detection within network traffic of a cloud-computing environment according to some embodiments;

FIG. 6B is a graphical representation of an interface screen displaying data pertaining to monitored VPCs in accordance with some embodiments; and

FIG. 6C is a graphical representation of an interface screen configured to receive user input indicating instructions for managing the monitoring of designated VPCs in accordance with some embodiments.

### DETAILED DESCRIPTION

### I. Terminology

In the following description, certain terminology is used to describe features of the invention. In certain situations, the terms “logic” and “component” is representative of hardware, firmware, and/or software that is configured to perform one or more functions. As hardware, the logic or component may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic or component may be software in the form of one or more software modules. The software module(s) may include an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “computerized” generally represents that any corresponding operations are conducted by hardware in combination with software and/or firmware.

The term “host” may be construed as a virtual or physical logic. For instance, as an illustrative example, the host may correspond to virtual logic in the form of a software component (e.g., a virtual machine), which is assigned a hardware address (e.g., a MAC address) and an IP address within an IP address range supported by to a particular IP subnet. Alternatively, in some embodiments, the host may correspond to physical logic, such as an electronic device that is communicatively coupled to the network and assigned the hardware (MAC) address and IP address. Examples of electronic devices may include, but are not limited or restricted to a personal computer (e.g., desktop, laptop, tablet or netbook), a mobile phone, a standalone appliance, a sensor, a server, or an information routing device (e.g., a router, bridge router (“brouter”), etc.). Herein, the term “on-premises host” corresponds to a host residing as part of the “on-premises” (or local) network while a “cloud host” corresponds to a host residing as part of a public cloud network.

The term “cloud computing infrastructure” generally refers to a networked combination of hardware and software including one or more servers that each include circuitry for managing network resources, such as additional servers and computing devices. The cloud computing infrastructure also includes one or more communication interfaces as well as communication interface logic.

The term “gateway” may refer to a software instance deployed within a VPC that controls the flow of data traffic from the VPC to one or more remote sites including computing devices that may process, store and/or continue the routing of data. The terms “transit gateway” and “spoke gateway” may refer to gateways having similar architectures but are identified differently based on their location/configurations within a cloud computing platform. For instance, a “spoke” gateway is configured to interact with targeted instances while a “hub” gateway is configured to further assist in the propagation of data traffic (e.g., one or more messages) directed to a spoke gateway within a spoke VPC or a computing device within an on-premises network.

The term “controller” may refer to a software instance deployed within a cloud computing platform that manages operability of certain aspects of the cloud computing platform. For instance, a controller collects information pertaining to each VPC and configures a VPC routing table associated with each VPC to establish communication links (e.g., logical connections) between a certain spoke gateway and cloud instances associated with a particular instance subnet. A VPC routing table is programmed to support communication links between different sources and destinations, such as an on-premise computing devices, a cloud instance within a particular instance subnet or the like. In addition, the controller establishes each gateway instance and manages operability of the gateways by, for example, configuring gateway routing tables each of the gateways within each VPC. Further, the controller may manage the establishment of secure communication links (e.g., IPSec tunnels) between each spoke VPC and a hub VPC deployed within a cloud computing platform.

The term “message” generally refers to information in a prescribed format and transmitted in accordance with a suitable delivery protocol. Hence, each message may be in the form of one or more packets, frames, or any other series of bits having the prescribed format.

The term “transmission medium” may be construed as a physical or logical communication path between two or more electronic devices. For instance, as a physical communication path, wired and/or wireless interconnects in the form of electrical wiring, optical fiber, cable, bus trace, or a wireless channel using infrared, radio frequency (RF), may be used.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. General Architecture

Embodiments of the disclosure are directed to a system configured to provide operational visibility for networking using one or more cloud computing environments (also referred to herein as “multi-cloud networking”). Some embodiments of the system include logic, e.g., processing on a first computing resource such as a cloud computing resource, and one or more controllers. Herein, such as system with be referred to as the Topology System.

As noted above, a controller may be a software instance deployed within a cloud computing platform that manages operability of certain aspects of the cloud computing platform. For instance, a controller collects information pertaining to each VPC and configures a VPC routing table associated with each VPC to establish communication links (e.g., logical connections) between a certain spoke gateway and cloud instances associated with a particular instance subnet. A VPC routing table is programmed to support communication links between different sources and destinations, such as an on-premise computing devices, a cloud instance within a particular instance subnet or the like. Thus, the controller obtains and stores information that reveals certain characteristics and communication links of resources managed by the controller such as gateways as well as any subnets within the purview of the controller.

Specifically, the Topology System enables collection and storage of such information across multiple cloud computing environments (“clouds”). By enabling collection and storage of such information across multiple clouds, the Topology System is configured to provide a visualization of connections between resources for multiple clouds, and the state of resources and connections between resources for multiple clouds. Additionally, the Topology System is configured to provide searchability of the information detailing resource parameters, the connections between resources and the status of various resources as well as a visualization of the search results.

Embodiments of the disclosure offer numerous advantages over current systems that provide a dashboard illustrating parameters of a controller as current systems today do not provide the ability to visualize connections between resources for multiple clouds, and the state of resources and connections between resources for multiple clouds.

As one example, an enterprise network may span several clouds and an administrator of the enterprise may desire to have a visual of the status of all resources and connections therebetween on the enterprise network. However, because the enterprise network spans multiple clouds, current systems do not enable the administrator to visualize beyond a single cloud. Thus, by merely obtaining a visual of a single cloud, an administrator is unable to obtain a full view of the resources, connections therebetween and the status of each. As used herein, a visual display of the resources, connections therebetween and the status of each is referred to as a topology mapping. Current systems do not provide a topology mapping across multiple clouds. Current systems not only fail to provide the administrator with a full topology mapping of the enterprise network, current systems also fail to allow the administrator to search across multiple clouds or visualize how changes in a state of a resource or connection in one cloud affects the state of a resource or connection in a second cloud.

As will be discussed in further detail below, embodiments of the disclosure are directed to systems, methods and apparatuses for enabling an administrator, or other user, to see a topology mapping for an entire enterprise network even when spanning multiple clouds. Further, the visualization of the topology mapping may automatically change as a state of a resource or connection changes (e.g., a “dynamic topology mapping”).

In one embodiment, a network may be deployed across multiple clouds using a plurality of controllers to manage resources (e.g., gateways) and network connections. Further, the logic of the Topology System may be stored and processed on a server device or cloud computing resource and query the plurality of controllers for data pertaining to the topology of the network by transmitting one or more proprietary API calls to each controller for specified data, which may be stored by each controller on one or more internal databases. The logic receives the requested data, generates the topology mapping and generates one or more GUI screens to display the topology mapping to an administrator. The logic may be configured to receive user input such as a selection of one or more filters and display a filtered data set accordingly that that includes data spanning multiple clouds. Additionally, the logic may be configured to receive user input such as a search term and display a filtered data set accordingly that that includes data spanning multiple clouds.

### III. Exemplary Graphical User Interfaces

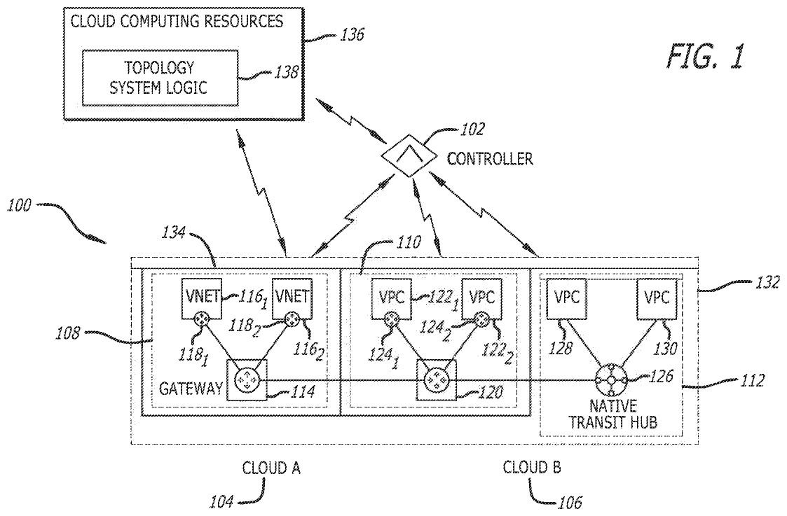

Referring to FIG. 1, a diagram of an exemplary embodiment of a distributed cloud management system 100 is shown, where the cloud computing system features a controller 102 for managing constructs residing in multiple cloud networks (which may comprise a “networked cloud environment” and may, in some embodiments, comprise the enterprise network referenced above) and a software instance 138 to visualize the managed constructs (hereinafter, “topology system logic”). More specifically, the controller 102 is configured to manage multiple constructs spanning multiple cloud networks, such as cloud (network) A 104 and cloud (network) B 106. In the exemplary illustration, cloud A 104 provides computing resources (“resources”) for a transit gateway 114 in communication with gateways 118₁-118₂ associated with virtual networks (VNETs) 116₁-116₂. Cloud B 106 provides resources for a transit gateway 120 in communication with gateways 1241-124₂ associated with virtual private clouds (VPCs) 122₁-122₂. Cloud B 106 further provides resources for a native transit hub 126 in communication with VPCs 128 and 130. According to this embodiment of the disclosure, as shown in FIG. 1, the transit gateways 114, 120 and the native transit hub 126 are in communication with each other. Thus, as should be clearly understood that the controller 102 is managing several constructs, such as the illustrated gateways, that span multiple cloud networks.

Specifically, a first grouping of constructs 108 is deployed within the Cloud A 104, and second and third groupings of constructs 110, 112 are deployed within Cloud B 106. The controller 102 utilizes a set of APIs to provide instructions to and receive data (status information) associated with each of these constructs as well as status information pertaining to each connection between these constructs (link state). The construct metadata returned by a construct may depend on the type of construct (e.g., regions, VPCs, gateway, subnets, instances within the VPCs, etc.), where examples of construct metadata may include, but is not limited or restricted to one or more of the following construct parameters (properties): construct name, construct identifier, encryption enabled, properties of the VPC associated with that construct (e.g. VPC name, identifier and/or region, etc.), cloud properties in which the construct is deployed (e.g., cloud vendor in which the construct resides, cloud type, etc.), or the like.

Additionally, the cloud management system 100 includes topology system logic 138 processing on cloud computing resources 136. In some embodiments, the topology system logic 138 may be logic hosted on a user's Infrastructure as a Service (IaaS) cloud or multi-cloud environment. As one example, the topology system logic 138 may be launched as an instance within the public cloud networks (e.g., as an EC2® instance in AWS®). As an alternative example, the topology system logic 138 may be launched as a virtual machine in AZURE®. When launched, the topology system logic 138 is assigned a routable address such as a static IP address for example.

As shown, the topology system logic 138 is in communication with the controller 102 via, for example, an API that enables the topology system logic 138 to transmit queries to the controller 102 via one or more API calls. The topology system logic 138, upon execution by the cloud computing resources 136, performs operations including querying the controller 102 via API calls for construct metadata in response to a particular event. The particular event may be in accordance with a periodic interval or an aperiodic interval or a triggering events such as a user request for a visualization via user input.

In some embodiments, in response to receiving a query via an API call from the topology system logic 138, the controller 102 accesses data stored on or by the controller 102 and returns the requested data via the API to the topology system logic 138. For example, the topology system logic 138 may initiate one or more queries to the controller 102 to obtain topology information associated with the constructs managed by the controller 102 (e.g., a list of all gateways managed by the controller 102, a list of all VPCs or VNETs managed by the controller 102, or other data gathered from database tables) along with status information associated with each construct as described above.

Upon receiving the requested construct metadata, the topology system logic 138 performs one or more analyses and determines whether any additional construct metadata needs to be requested. For example, the topology system logic 138 may provide a first query to the controller 102 requesting a list of all gateways managed by the controller 102. In response to receiving the requested construct metadata, the topology system logic 102 determines the interconnections between the gateways listed. Subsequently, the topology system logic 138 may provide a second query to the controller 102 requesting a list of all VPCs managed by the controller. In response to receiving the requested construct metadata, the topology system logic 138 determines the associations between each VPC and a corresponding gateway.

For example, in some embodiments, the received construct metadata provides detailed information for each gateway enabling the topology system logic 138 to generate a data object, e.g., a database table of the construct metadata, that represents a gateway. The data object representing the multiple gateways are cross-referenced to build out a topology mapping based on the parameters of each gateway, which may include, inter alia: cloud network user account name; cloud provider name; VPC name; gateway name; VPC region; sandbox IP address; gateway subnet identifier; gateway subnet CIDR; gateway zone; name of associated cloud computing account; VPC identifier; VPC state; parent VPC name; VPC CIDR; etc. Similarly, the construct metadata is also utilized to generate a data object representing each VPC object and each subnet object.

Additionally, in order to determine whether a connection within the network is between two transit gateways, a separate API call may be utilized by the topology system logic 138 to query the controller 102 for a listing of all transit gateways. Thus, the topology system logic 138 is then able to determine whether a connection between a first gateway and a second gateway is between two transit gateways. In some embodiments, as will be discussed below, the connections between transit gateways and the connections between a spoke gateway and a transit may be represented visually in two distinct methods.

In addition to receiving the construct metadata from the controller 102, the topology system logic 138 may also receive network data from one or more gateways managed by the controller 102. For example, the network data may include for each network packet, but is not limited or restricted to, an ingress interface, a source IP address, a destination IP address, an IP protocol, a source port for UDP or TCP, a destination port for UDP or TCP, a type and code for ICMP, an IP “Type of Service,” etc. In one embodiment, the network data may be transmitted to the topology system logic 138 from a gateway using an IP protocol, for example, UDP. In some embodiments, the network data is collected and exported via the NetFlow network protocol.

In order to configure a gateway to transmit the network data to the topology system logic 138, the topology system logic 138 may provide instructions to the controller 102, which in turn provides the instructions to each gateway managed by the controller 102. The instructions provide the IP address of the topology system logic 138, which is used as the IP address for addressing the transmission of the network data.

As will be discussed in detail below, the topology system logic 138 may generate a visualization platform comprising one or more interactive display screens. These display screens may include a dashboard, a topology mapping and a network flow visualization. Additionally, the visualization platform may be configured to receive user input that causes filtering of the displayed data.

For example and still with reference to FIG. 1, the topology system logic 138 may generate a topology mapping visualization of the connections linking the constructs detected by the controller 102, which are illustrated by the constructs within a logical region 132 represented by Cloud A 104 and Cloud B 106. Additionally, the topology system logic 138 may generate various graphical user interfaces (GUIs) that illustrates network traffic flows, traffic flow heat maps, packet capture, network health, link latency, encryption, firewalls, etc., of network traffic flowing between, to and from constructs managed by the controller 102 as illustrated by a second logical region 134.

Embodiments of the disclosure offer numerous advantages over current systems that provide a dashboard illustrating parameters of a controller as current systems do not provide the ability to visualize connections between constructs deployed across multiple cloud networks, the state of resources and connections between resources for multiple clouds and the flow of network data through constructs spanning multiple clouds. As one example, an enterprise network may utilize resources deployed in a plurality of cloud networks and an administrator of the enterprise network may desire to obtain visualization of the status of all constructs and connections associated with these resources. However, because the enterprise network spans multiple cloud networks, conventional systems fail to provide such a solution. By merely obtaining a textual representation of a status of each construct within a single cloud (e.g., through a command line interface), an administrator is unable to obtain a full view of the constructs, connections therebetween and the status of each for the entire enterprise network. Further, detection of anomalous or malicious network traffic patterns may not be detectable in the manner provided by current systems.

As used herein, a visualization (or visual display) of the constructs, connections therebetween and the status of each is referred to as a topology mapping. Current systems fail to provide a topology mapping across multiple cloud networks and fail to allow an administrator to search across multiple cloud networks or visualize how changes in a state of a construct or connection in a first cloud network affects the state of a resource or connection in a second cloud network. In some embodiments, the topology mapping may automatically change as a state of a construct or connection changes or upon receipt of construct metadata updates in response to certain events such as at periodic time intervals (e.g., a “dynamic topology mapping”).

In some embodiments, a network may be deployed across multiple cloud networks using a plurality of controllers to manage operability of the network. In some such embodiments, each controller may gather the information from the network and constructs which it manages and a single controller may obtain all such information, thereby enabling the visualization platform to provide visibility across a network (or networks) spanning multiple controllers.

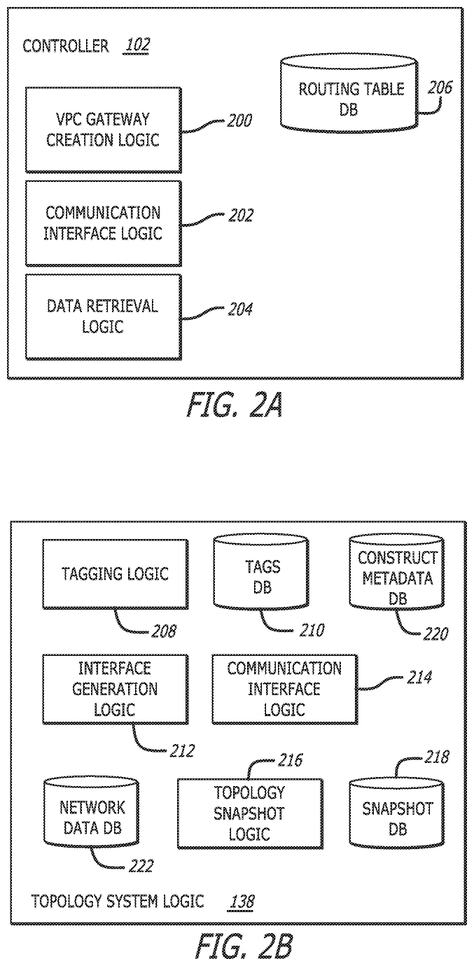

Referring to FIG. 2A, an exemplary illustration of a logical representation of the controller 102 deployed within the cloud management system 100 is shown in accordance with some embodiments. The controller 102, as noted above, may be a software instance deployed within the cloud network to assist in managing operability of constructs within multiple public cloud networks. According to this embodiment, the controller 102 may be configured with certain logic modules, including, a VPC gateway creation logic 200, a communication interface logic 202 and a data retrieval logic 204. The controller 102 may also include a routing table database 206.

In some embodiments, the gateway creation logic 200 performs operations to create a gateway within a VPC including creating a virtual machine within a VPC, provide configuration data to the virtual machine, and prompt initialization of the gateway based on the configuration data. In one embodiment in which the cloud computing resources utilized are AWS®, the VPC gateway creation logic 200 launches a virtual machine within a VPC, the virtual machine being an AMAZON® EC2 instance. The virtual machine is launched using a pre-configured virtual machine image published by the controller 102. In the particular embodiment, the virtual machine image is an Amazon Machine Image (AMI). When launched, the virtual machine is capable of receiving and interpreting instructions from the controller 102.

The communication interface logic 202 may be configured to communicate with the topology system logic 138 via an API. The controller 102 may receive queries from the topology system logic 138 via one or more API calls and respond with requested data via the API.

The data retrieval logic 204 may be configured to access each construct managed by the controller 102 and obtain construct metadata therefrom. Alternatively, or in addition, the data retrieval logic 204 may receive such construct metadata that is transmitted (or “pushed”) from the constructs without the controller 102 initiating one or more queries (e.g., API calls).

The routing table database 206 may store VPC routing table data. For example, the controller 102 may configure a VPC routing table associated with each VPC to establish communication links (e.g., logical connections) between a transit gateway and cloud instances associated with a particular instance subnet. A VPC routing table is programmed to support communication links between different sources and destinations, such as an on-premise computing devices, a cloud instance within a particular instance subnet or the like. Thus, the controller 102 obtains and stores information that reveals certain properties of resources (e.g., constructs such as gateways, subnets, VPCs, instances within VPCs, etc.) within the purview of the controller 102 as well as status information pertaining to the connections (communication links) between with these resources.

Referring to FIG. 2B, an exemplary illustration of a logical representation of the topology system logic 138 deployed within a cloud computing platform is shown in accordance with some embodiments. The topology system logic 138 may be a software instance deployed using the cloud computing resources 136 and is configured to communicate with the controller 102 and each of the gateways managed by the controller 102. The topology system logic 138 is configured with certain logic modules, including, a tagging logic 208, a tags database 210, an interface generation logic 212, a communication interface logic 214, a topology snapshot logic 216. Additionally, the topology system logic 138 may include a snapshot database 218, a construct metadata database 220 and a network data database 222.

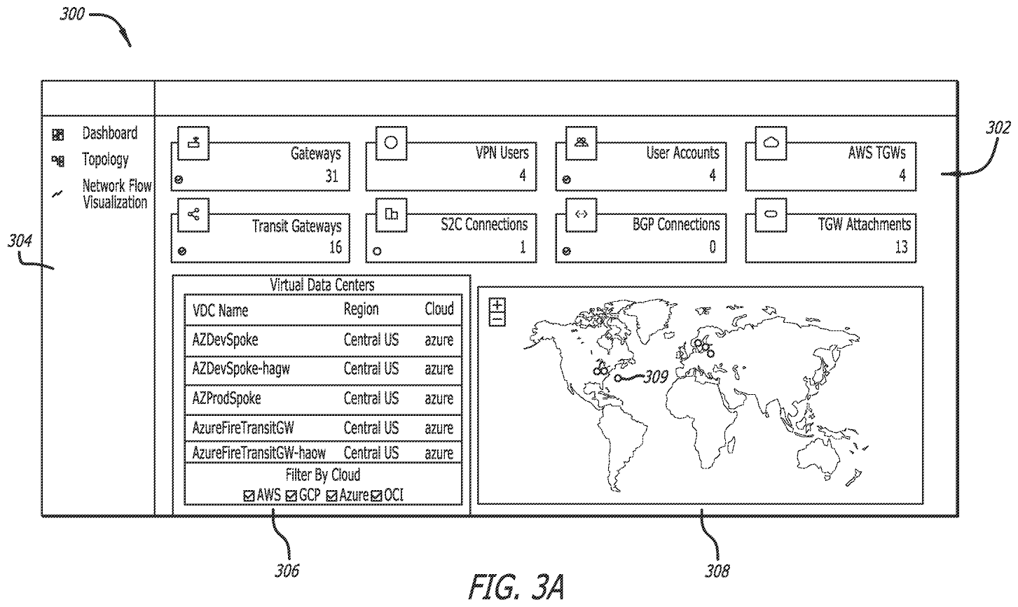

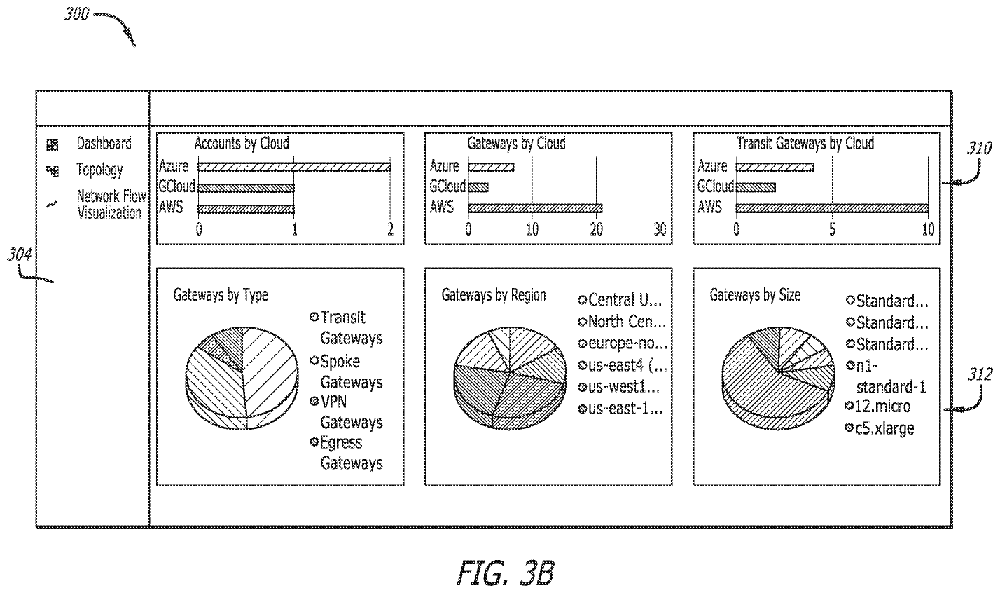

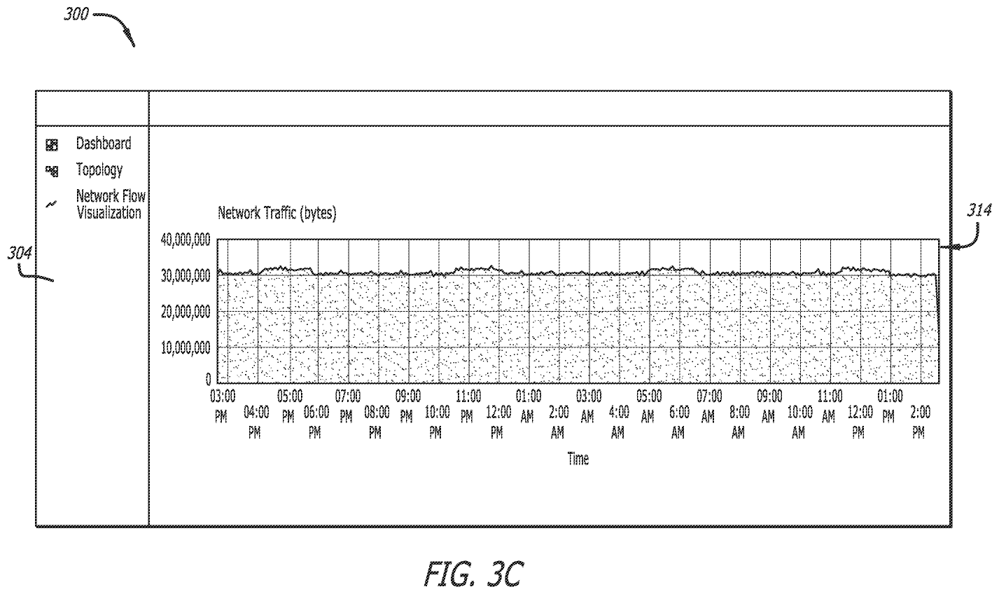

In some embodiments, the interface generation logic 212, upon execution by one or more processors, performs operations as discussed below and that cause generation of exemplary interactive user interfaces as illustrated in FIGS. 3A-4C, 5B.

In some embodiments, the communication interface logic 214, upon execution by one or more processors, performs operations as discussed herein pertaining to querying a controller for construct metadata, receiving the requested construct metadata and receiving the network data from one or more gateways managed by the controller. In some embodiments, the received construct metadata and network data may be stored in the construct metadata database 220 and the network data database 222 (which may be separate or a combined database).

### IV. Exemplary User Interfaces—Topology System Visualization Platform

The exemplary user interfaces illustrated in FIGS. 3A-4C, 5B may be configured by the topology system logic 138 to be rendered and displayed on various display screens and via various applications. For example, each of the user interfaces illustrated in FIGS. 3A-4C, 5B may be configured to be displayed through a web browser on a computer display screen, a laptop, a mobile device, or any other network device that includes a web browser. Additionally, each of the user interfaces illustrated in FIGS. 3A-4C, 5B may be configured to be displayed through a dedicated software application installed and configured to be executed on any of the network devices described above. For example, the topology system logic 138 may be configured to provide the data and user interfaces described herein to a software application (known in the art as an “app”) that may be installed and configured to be executed by one or more processors of a network device. Thus, upon execution, the app causes the user interfaces described herein to be rendered on the display screen of the network device (or an associated display screen).

### 1. Dashboard

Referring now to FIGS. 3A-3C, graphical user interface (GUI) screens (or “interface screens”) displaying portions of a dashboard of a Topology System visualization platform (“visualization platform”) with each portion configured to illustrate information obtained or determined by the Topology System are shown according to some embodiments. The interface screens of FIGS. 3A-3C may collectively comprise a “dashboard” 300 that displays various attributes pertaining to a network that is deployed across one or more cloud providers, and notably across multiple cloud providers.

For example, the dashboard 300 as shown in FIG. 3A include several display portions 302, 306, and 308. The navigation panel 304 is also shown as part of the visualization platform generated by the topology system logic 138. The display portion 302 displays information pertaining to constructs managed by a controller, e.g., the controller 102 of FIG. 1, with the constructs deployed in one or more cloud networks. The information displayed may include, but is not limited or restricted to, the number of gateways deployed, the number of current virtual private network (VPN) users, the number of user accounts, the number of transient gateways (TGWs), the number of network connections (optionally filtered according to cloud computing service), the number of Border Gateway Protocol (BGP) connections, etc.

The display portion 306 of FIG. 3A includes a listing of virtual data centers comprising resources of the network, again optionally spanning multiple cloud networks. Specifically, the display portion 306 includes user input fields (e.g., checkboxes) configured to receive user input indicating how whether displayed by the dashboard 300 is filtered by one or more particular cloud networks (e.g., AWS®, GOOGLE® CLOUD PLATFORM® (GCP), AZURE® ORACLE CLOUD INFRASTRUCTURE® (OCI)). In some embodiments, a virtual data center is a pool of cloud computing resources that may be hosted on a public cloud.

Further, display portion 308 illustrates a world map including a graphical representation, e.g., such as the icon 309, for each virtual data center listed in the display portion 306 and a position on the world map to signify its geographical location. The display portion 308 may be filtered in accordance with the selection of “Filter By Cloud” provided in the display portion 306 and may be configured to receive user input to adjust the magnification of the map (e.g., “zoom in” or “zoom out”).

The navigation panel 304 includes links to each of the general visualizations provided by the visualization platform including the dashboard 300, which may encompass or provide access to any of the interface screens disclosed herein such as the interface screens 400, 418, 420, and 504.

Referring now to FIG. 3B, an illustration of a portion of the dashboard 300 displaying a plurality of graphs and charts is shown through a plurality of display portions 310 and 312. Each of the display portions 310 and 312 each display a distribution of resources throughout a multiple cloud deployment.

For instance, as an illustrative embodiment, the display portion 310 features a number of bar graphs illustrating metrics directed to resources managed by the controller; however, as should be understood by review of the drawings accompanying this disclosure, bar graphs are merely one type of illustration that may be utilized to present data and the disclosure is not intended to be so limited to the specific graphical representation types shown. Display portion 310 illustrates that the data displayed on the dashboard corresponds to constructs and network traffic spanning multiple cloud networks by specifically displaying “Accounts by Cloud,” “Gateways by Cloud” and “Transit Gateways by Cloud.” Similarly, the display portion 312 provides graphical representations directed toward gateway metrics, including “Gateways by Type,” “Gateways by Region” and “Gateways by Size.” In some embodiments, the gateway metrics include one or more of a total of gateways deployed, a number of virtual private network (VPN) users, a number of user accounts associated with one or more gateways, a number of transit gateways, a number of gateways deployed by a specific cloud computing resource provider, a number of Border Gateway Protocol (BGP) connections, or a number of transient gateway attachments.

FIGS. 3A-3B illustrate various metrics and characteristics of gateways, where the metrics may include one or more of: a total of gateways deployed, a number of virtual private network (VPN) users, a number of user accounts, a number of transit gateways, a number of gateways deployed by a specific cloud computing resource provider, a number of Border Gateway Protocol (BGP) connections, or a number of transient gateway attachments.

Further, one or more metrics may be derived from or based on gateway characteristics, which may include one or more of a cloud computing network in which each gateway is deployed, a type of each gateway, a size of each gateway, or a geographic region in which each gateway is deployed.

Referring now to FIG. 3C, an illustration of another graphical representation of network functionality or operations or operability, based on data gathered and processed by the topology system logic 138 and displayed as part of the dashboard 300, is shown. More specifically, according to this illustrative embodiment, the display portion 314 provides a graphical representation of network traffic between resources spanning multiple cloud networks for an adjustable time period (e.g., 24 hours). The time period may be adjusted by the topology system logic 138 based on receipt of user input. For example, user input may be received corresponding to selection of a portion of the graph shown by the user. In response to such received user input, the topology system logic 138 may alter the graphical representation to target the selected portion that now may be represented by a smaller time interval, e.g., 15 minutes, 30 minutes, one hour, etc.

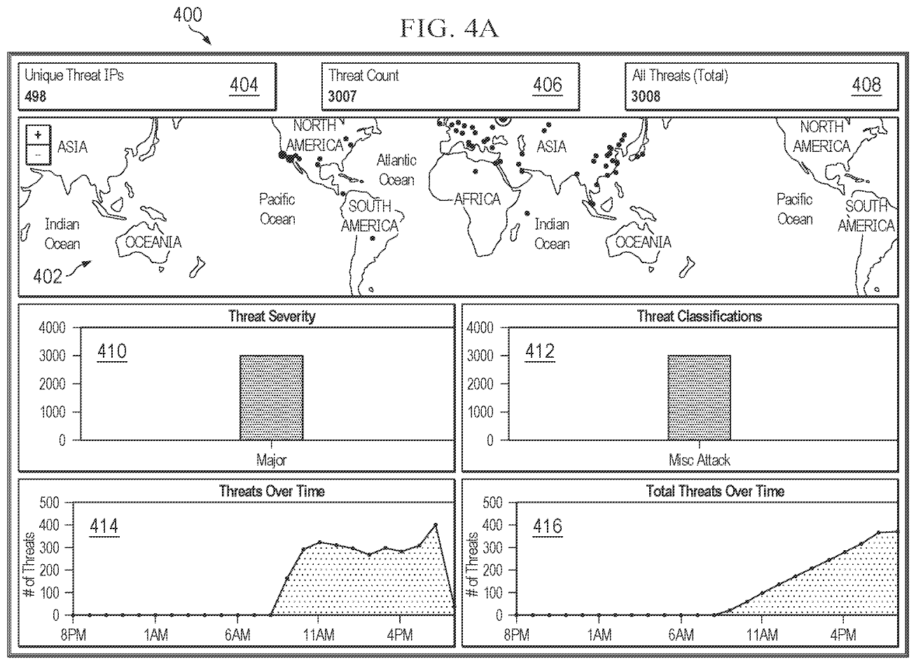

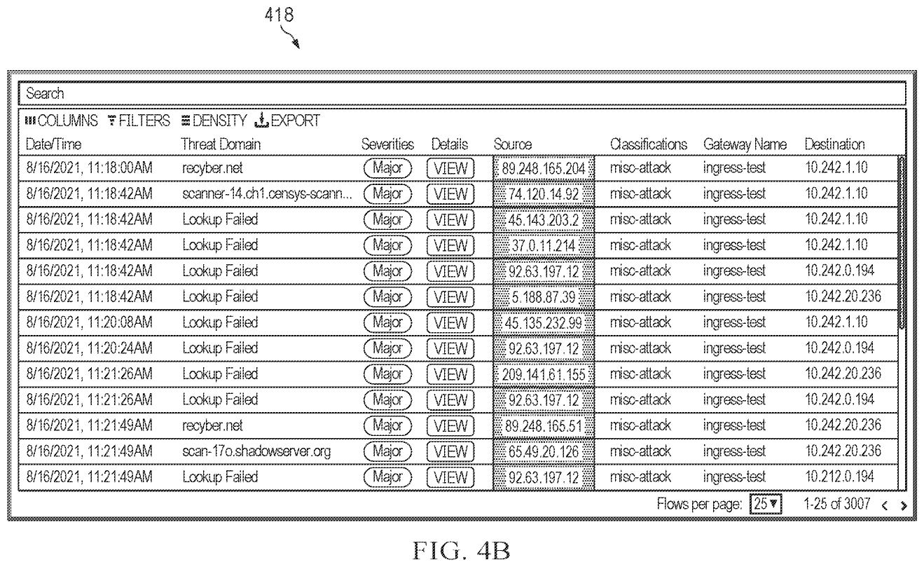

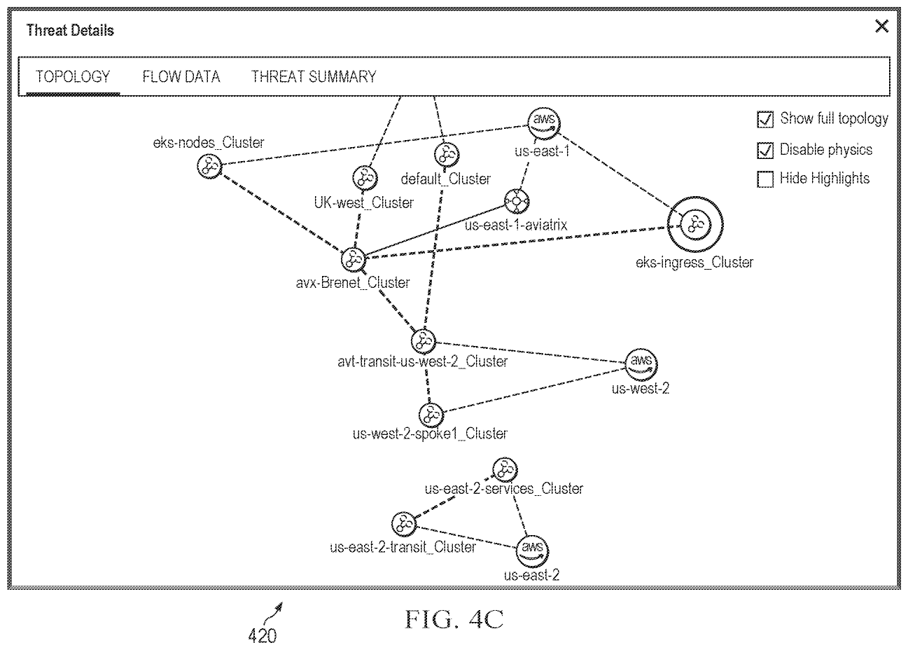

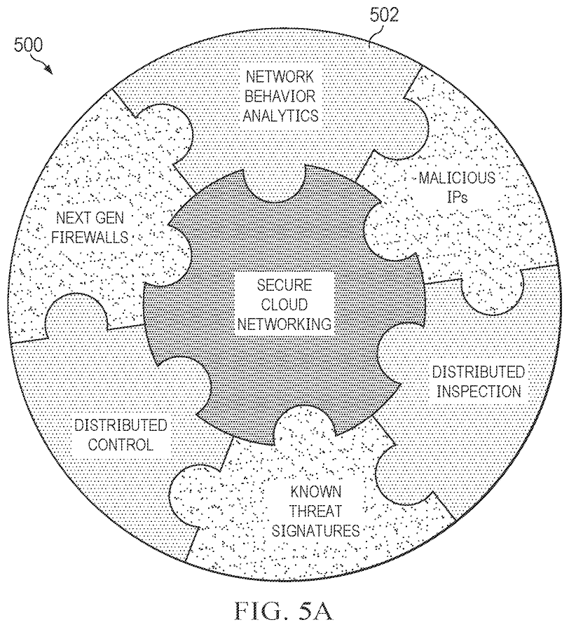

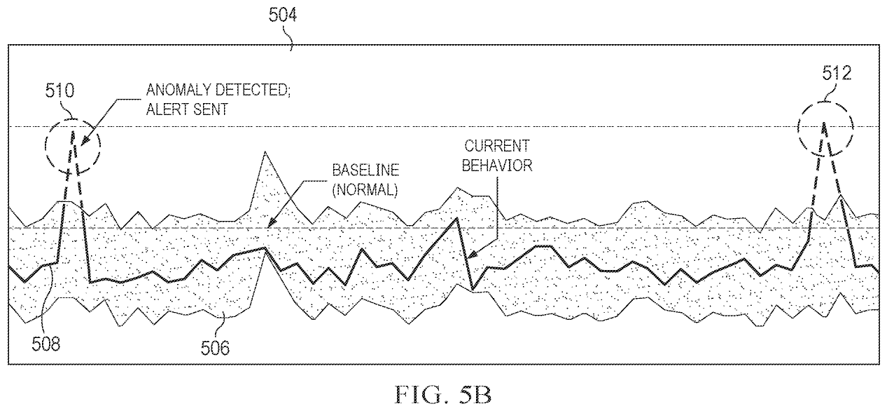

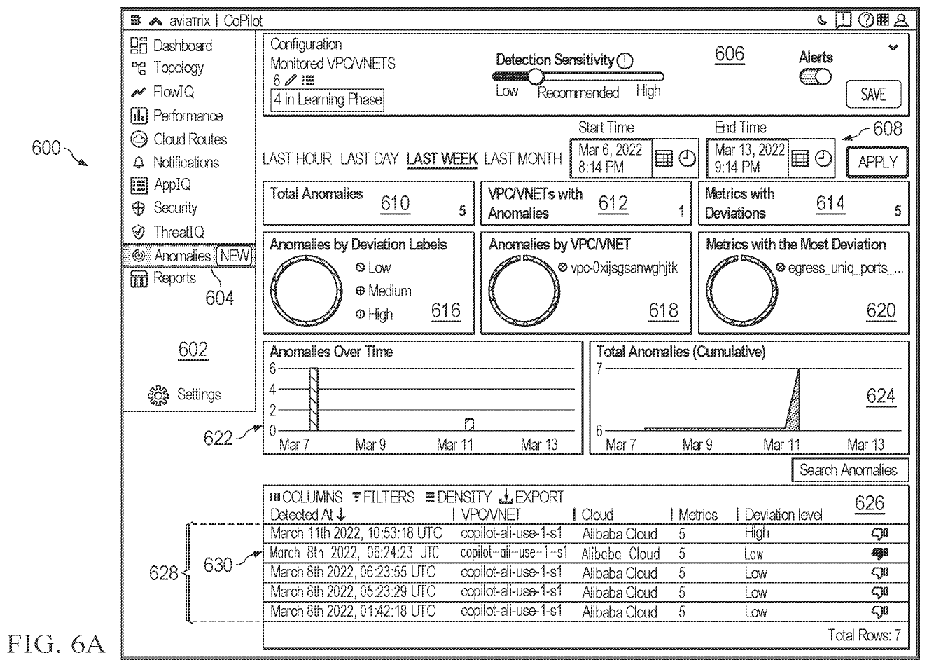

In some embodiments, the dashboard 300 (and other visualizations discussed in FIGS. 4A-5G) are generated are a result of user input requesting such visualizations. In some embodiments, in response to receiving the request, the topology system logic 138 will request the construct metadata as discussed above, and store the construct metadata and the latest network data received from the gateways in a data store (such as the construct metadata database 220 and/or the network data database 222, which as noted above, may be a single database). Additionally, the topology system logic 138 then generates the requested visualization based on the stored data.

In some embodiments, the topology system logic 138 will automatically update the visualizations (e.g., generate an updated visualization and cause the re-rendering of the display screen) at periodic time intervals (e.g., every 30 seconds, every 1 minute, etc.). In some embodiments, an updated visualization will be generated and displayed upon occurrence of a triggering event, such as receipt of user input requesting a refresh of the display screen. The updated visualizations will be updated based on newly received or obtained construct metadata and/or network data since the previous rendering.

### V. Monitoring Functionality—ThreatIQ

As discussed above, the distributed cloud management system 100 may provide displays that include visual elements to demonstrate constructs residing in multiple cloud networks. Further, the distributed cloud management system 100 may enable an administrator to assign constructs to segments within a networked cloud environment, where constructs outside of the same segment may be prevented from communicating with each other. The segments are enabled by way of security domains and the ability of constructs within a segment to communicate with each other is dictated by security domain policies. The security domains may be generated and enabled via the controller 102 (or optionally via the topology system logic 130). Any security domain policies for each segment may also be generated and enabled in a similar manner. Thus, the interfaces generated by the topology system logic 138 may illustrate the logical and physical view of the domain segments and their connection relationships.

An additional feature provided by the distributed cloud management system 100 is a security monitoring feature (“ThreatIQ”) that enables the monitoring for security threats in a networked cloud environment, generates and transmits alerts when threats are detected in the networked cloud environment (e.g., within the network traffic flows), and may be configured to block traffic that is associated with threats. All such capabilities apply to an entire networked cloud environment (multi-cloud or single cloud) that is managed by the controller 102.

In some embodiments, the alerts are generated when current behavior exceeds certain thresholds (e.g., nearing an outer limit of the baseline range or an amount outside of the baseline range).

The ThreatIQ feature provides visibility into known malicious threats that have attempted to communicate with constructs within the entire networked cloud environment. In some embodiments, the controller 102 or the topology system logic 138 may store (or otherwise access) a listing of well-known malicious sites or IP addresses known to be bad actors (“threat IPs”). Network traffic and construct data is obtained by the topology system logic 138 from gateways deployed by the controller 102 and/or from the controller 102 itself (in real time) and the topology system logic 138 analyzes the network traffic and construct data to detect traffic from threat IPs. In some embodiments, the analysis may include a comparison with a database of known malicious hosts.

Referring now to FIGS. 4A-4C, exemplary graphical user interfaces illustrating a monitoring feature enabled by the distributed cloud computing system of FIG. 1 are shown according to some embodiments. Referring to FIG. 4A, an interface screen displaying portions of a dashboard of the visualization platform with each portion configured to illustrate information obtained or determined by the topology system is shown according to some embodiments. The interface screen 400 may be an additional interface screen comprising the dashboard 300 discussed above. The data collected by the distributed cloud computing system of FIG. 1 that is utilized in analyses for generating the interface screens discussed above may also be the data that is utilized in analyses resulting in the generation of the interface screen 400. More specifically, the data may include various attributes pertaining to a network that is deployed across one or more cloud providers, and notably across multiple cloud providers.

The interface screen 400 of FIG. 4A may be referred to as a “Threats view,” which includes a geographical map portion 402 that illustrates the approximate geographic locations 403 of known malicious IPs that have communicated with networked cloud environment. Enumerations of the number of unique threats (enumeration 404), the threat count (enumeration 406), and an all threat count (enumeration 408) may be provided. Further, the severity level of threat IPs detected may be provided via a graphical representation 410 and an attack classification of each threat may be provided via the graphical representation 412. Additionally, a graphical representation 414 may be provided that illustrates threats over a specified time period and a graphical representation 416 may be provided that illustrates total threats over time.

Referring to FIG. 4B, an interface screen displaying portions including detailed information of the threats discussed with respect to FIG. 4A is shown according to some embodiments. The interface screen 418 illustrates detailed information about each threat record including the source IP of the threat, the destination IP, the gateways where the threat-IP traffic traversed, the associated traffic flow data (date and time, source and destination ports, etc.), and threat information such as why a particular threat was deemed a threat. For each threat record, a network topology map 420 may be accessed where the associated compromised gateway is highlighted (see FIG. 4C). Once viewing the topology map 420, a drill down into the map to the instance level where the compromised instance (that is communicating and egressing to the threat IP) is highlighted may be performed. Such a topology view makes it easy to identify the subnet the compromised server was deployed on and the transit gateway it was using to communicate with the threat IP.

While the ThreatIQ Threats view provides visibility into the threats detected in your network, additional functionality may include taking actions on those threats such as enabling alerts to be notified when threat-IP traffic is first detected (e.g., via a preferred communication channel (email)) or viewing historical information about when the alerts were triggered, including the names of the gateways within the threat-IP traffic flow via an interface screen generated by the topology system logic 138. Additionally, threat-IP traffic may be blocked. Upon first detecting a threat IP in a traffic flow, the controller 102 or the topology system logic 138 instantiates security rules (stateful firewall rules) on all gateways that are within that flow (all gateways within the VPC, VNET, virtual cloud network (VCN)) to immediately block the threat-IP associated traffic. If the threat IP is removed from the database of the threat-IP source, the controller 102 may automatically remove the security rules for that specific threat IP from the affected gateways and associated traffic is no longer blocked. Otherwise, the security rules for that specific threat IP remain enforced.

### VI. Network Behavior Analysis

In addition to the functionalities discussed above, as part of a broader security platform enabled by the distributed cloud computing system of FIG. 1, the topology system logic may include a network behavior analytics feature. Referring to FIG. 5A, a graphical representation of functionalities associated with the broader security platform 500 is shown in accordance with some embodiments. Specifically, FIG. 5A illustrates that network behavior analytics 502 is one component of such a platform 500 that also includes one or more components such as next generation firewalls, distributed control (e.g., construct segmenting), known threat signature detection, distributed inspection (e.g., inspection of network traffic in to and out of segments), and/or malicious IPs detection.

As is understood by security experts and network administrators, cloud networking presents new threat vectors, which often require novel defense approaches. For instance, the fundamental security challenge has evolved due to the migration of constructs and network traffic within the cloud as the exposure of a networked cloud environment is expanded such that there is no single perimeter, e.g., the number of ways or points to access a particular construct may be unlimited.

As a result, the migration to cloud computing has increased the complexity for security experts and network administrators. For instance, traditional security solutions (e.g., those typically deployed prior to cloud computing migration) leave gaps in the network security of an enterprise. For example, traditional security systems focused on a single point of inspection (e.g., ingress/egress) and were typically signature based (e.g., mainly utilized signatures of known bad actors). However, such systems fail to protect against threats in the cloud as there is no single access point with traditional cloud computing (e.g., no single entry point into an enterprise network as was the case when all network devices of an enterprise were located on-site). Additionally, systems that rely on signatures of known bad actors are typically out-of-date by the time a signature is generated as bad actors may hide their IP addresses or otherwise skew their signature so as to go undetected. Further, such systems struggle with zero-day attacks as such threats have not previously been seen and no signatures have been developed.

Further, and more specific to the ability of the distributed cloud computing system of FIG. 1 to provide visibility and perform analytics over a networked cloud environment that spans multiple clouds, cloud service providers may provide some analysis within a single cloud but cannot provide network behavior analytics across constructs spanning multiple clouds.

It is understood that these flaws of traditional security systems result in a high business risk to enterprises including data loss, exfiltration, and resource hijacking, which may lead to a loss of customer trust and have a devastating financial impact.

Referring to FIG. 5B, an interface displaying of results of an analysis involving network behavior analytics is shown in accordance with some embodiments. The interface 504, which may be an additional interface screen comprising the dashboard 300 discussed above, includes a graphical representation of a baseline 506 established for a particular set of network traffic, which is shown as a band (or range) of a measured value (e.g., bytes) over time. The baseline 506 is a fingerprint of an aspect of the networked cloud environment that is generated over time, with a baseline referring to a particular metric. Example metrics for which a baseline may be generated include, but are not limited or restricted to, data exfiltration (data outbound on individual or aggregate VPCs/VNETs), lateral movement (network traffic moving from one VPC/VNET within the cloud networked environment to another), use of ports and/or protocols (e.g., amount of new ports used over time, the amount of data transmitted using a particular protocol over time), distributed denial-of-service (DDoS) attacks (aggregate bandwidth inbound for a VPC/VNET), port scan detection (ports and protocols in use), and/or unencrypted traffic flows (identification of encrypted ports and protocols in use).

Using data exfiltration for an individual VPC as an example, an initial baseline may be generated using historical (or current) network traffic data that indicates an amount of outbound data transmitted from a particular VPC. In one embodiment, averages of outbound data may be determined for specified time periods to determine expected outbound data over those specified time periods, which represents the baseline. For example, an average of outbound data from a particular may be taken over for a day (e.g., 12:00 am-11:59 pm) using weeks, months, years, etc., of outbound data from the particular VPC (if available) such that the baseline represents the expected outbound data over any particular day. In some embodiments, the baseline for a particular day may be comprised of 1,440 ranges each representing a one minute interval, where a range is represented in a particular metric, such as 900-1,200 bytes.

However, a baseline may instead be more granular in its representation such that expected outbound traffic for minute (or several minute) intervals is represented over a day (e.g., expected network traffic fluctuates over the course of a day based). Thus, such a baseline may include expected outbound data from the particular VPC at minute intervals for any given calendar day. In some embodiments, such a baseline may be refined further to account for the expectations of outbound data transmission on a particular day (e.g., a particular weekday, a particular weekend (Saturday or Sunday), a particular holiday, etc.). Such refinement to either minute (or several minute) intervals over a day and either further to individual calendar days may be advantageous in increasing the accuracy of an outbound data baseline for a particular VPC for a specific time period of a specific day, e.g., such a baseline may more closely represent actual expected outbound data for a particular VPC at any particular minute of a calendar day.

In some embodiments, a baseline may be generated using machine learning techniques, such a supervised or unsupervised learning techniques. As one example, a feedforward neural network model may be trained using historical data and be configured to learn a baseline. An illustrative training process includes providing a multi-layer neural network with timestamped historical outbound data for a particular VPC (as training data) that is known to be expected (e.g., non-malicious) outbound data. The neural network generates a model that learns the expected outbound data for a given time period (e.g., minute intervals) resulting in the baseline 506. The generation of a baseline may be performed by the topology system logic 138.

The interface 504 also includes a current behavior indicator 508, which represents a plot of actual network traffic for a given metric over time. As shown in FIG. 5B, the current behavior indicator 508 may be displayed as an overlay on the baseline 506 such that a security expert or administrator may easily view how the current behavior compares to the baseline 506. As is also shown in FIG. 5B, spikes 510, 512 may represent anomalous (irregular, unexpected) behavior due to the fact the current behavior exited the baseline 506 (which represents expected behavior). A spike is not the only type of anomalous behavior that may be dedicated; instead, anomalous behavior may be any behavior that is outside of the baseline.

The network behavior analytics feature may detect the discrepancy between the current behavior (actual behavior) and the baseline, generate an alert, and transmit the alert to a security expert or administrator (or store the alert for later access). Thus, the network behavior analytics feature is advantageous compared to traditional security systems, especially those that utilize signatures for known bad actors, by determining expected behavior for a particular construct or constructs (e.g., an individual VPC or aggregation thereof) and detecting anomalous behavior as that a particular construct or constructs regardless of whether such behavior is associated with a known bad actor. When an anomalous behavior is detected, remediation actions may be taken such as blocking certain network traffic, diverging certain network traffic, etc.

Additionally, the baseline may be tuned over time to adapt to changing behaviors of a construct or aggregation thereof. For instance, as a networked cloud environment grows over time to add constructs within a particular VPC (e.g., increase the number of virtual machines (VMs) operating within a VPC), various baselines for that particular VPC may change over time (and similarly when VMs are removed). As one illustrative example, as additional VMs are deployed within a particular VPC, it is likely that the baseline amount of outbound data will change over time. Thus, a baseline may be tuned at regular intervals (e.g., adjusted using rolling historical data). For example, a baseline of outbound data for a particular VPC may be tuned on a monthly basis by determining a new baseline of outbound data for that particular VPC using network traffic metrics indicating outbound data for only the past three months.

In some embodiments, machine learning or other statistical analyses may also be utilized to predict future behavior based on current behavior. Thus, a regression analysis (e.g., use of any of linear regression, decision tree, support vector regression, Lasso regression, and/or random forest) may be utilized to determine a predicted value for the current behavior (e.g., at a particular future time). The predicted value may then be compared to the baseline for the future time such that similar an alert may be generated and/or remediation actions may be taken as discussed above.

A further advantage of the network behavior analytics feature described above is that such a feature may be specific to a particular enterprise and customized accordingly. Thus, unlike signatures of Threat IPs that are generated and distributed to all enterprises, the network behavior analytics feature is specific to a networked cloud environment and developed based on specific historical data (e.g., historical data of a specific VPC/VNET or aggregation thereof). Thus, such is not a “one size fits all” approach.

### 1. Further Technical Detail

In view of the above description, especially that corresponding to FIGS. 5A-5B, further technical detail is now provided as to the implementation and operability of anomaly detection performed by the topology system logic deployed within a cloud computing platform. As illustrated in FIG. 1, the topology system logic 138 is communicatively coupled to the controller 102 and the gateways of each deployed VPC (and as noted above, the term “VPC” includes any of a VPC, VNET, VCN, or comparable virtual private cloud, where such terminology may be dependent merely on the corresponding cloud service provider). Thus, the topology system logic 138 obtains data pertaining to network traffic flow from either/both of the controller 102 and individual gateways. As a result, the topology system logic 138 may monitor network traffic metrics at a VPC level (e.g., by monitoring network traffic at the gateway/gateways at each VPC). As also discussed above, the controller 102 is configured to deploy each VPC and the corresponding gateways and thus has access to this data pertaining to network traffic flow.

The ability to monitor the network traffic flow at the VPC level provides users of the topology system logic 138 with several advantages, one of which includes anomaly detection at the VPC level. Importantly, anomaly detection is distinguishable from traditional anomaly detection within network traffic, which in the current state of the art is performed as a centralized location for an entire network. For example, traditional anomaly detection may include routing all network traffic entering or exiting an enterprise network a central location of analysis prior to entering or exiting the enterprise network resulting in a congestion point, which often slows the flow of network traffic.

Additionally, analysis at a centralized location does not provide detailed information pertaining to a particular VPC and may not detect all anomalies. For instance, network traffic analyzed at a centralized location may appear normal at an enterprise network level but at a VPC level, network traffic may be spiking in an anomalous fashion and/or certain IP addresses or ports may be new or anomalous to a particular VPC. However, the amount of network traffic and/or the IP addresses/ports may not be anomalous for the entire enterprise and thus not be flagged as anomalous.

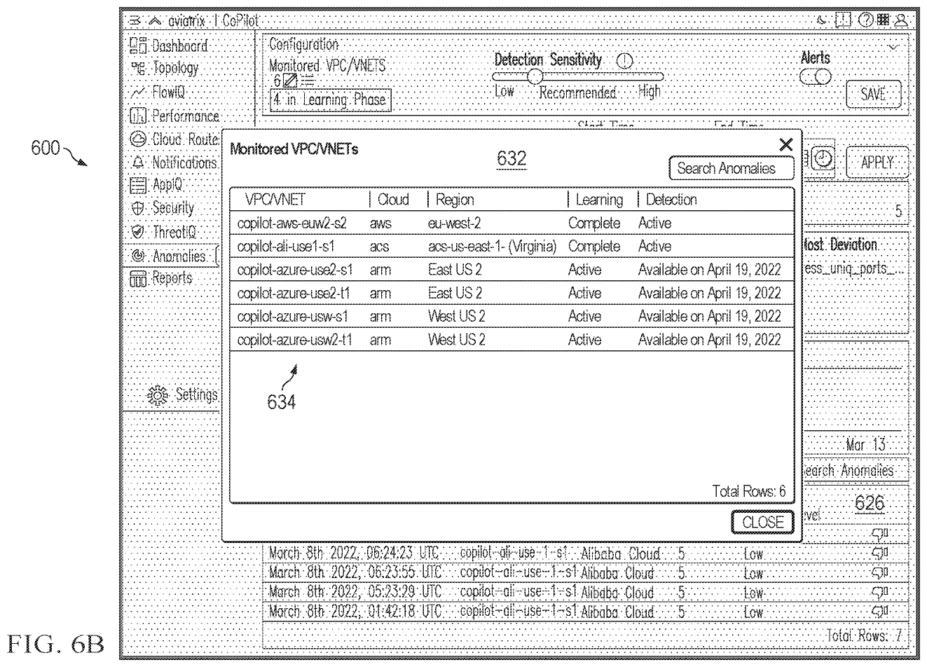

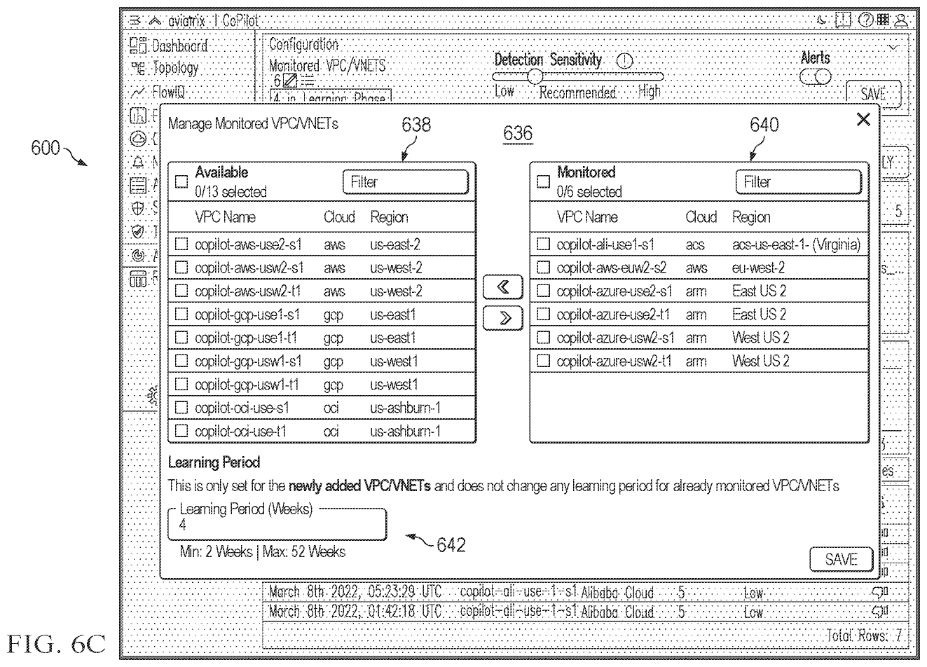

Thus, the anomaly detection at a VPC level provides a much more granular level of analysis and monitoring than that which may be provided by the current state of the art. As will be discussed further with respect to FIGS. 6A-6C, particular VPCs within a distributed cloud computing network may be selected for monitoring such that a baseline (or fingerprint) for each selected VPC may be generated based on monitoring a selected VPC during a learning period (e.g., predefined period of time). The fingerprint includes an analysis of various metrics for a selected VPC such as an amount of network traffic entering/exiting the VPC (optionally at various times of a day, days of the week, etc.), source and destination IP addresses, ports utilized, etc. As an example, a fingerprint may include an average of network traffic transmitted to and from a selected VPC for each hour of each day of the week as well as a list of known IP addresses and ports used. Thus, when real-time traffic is compared to the fingerprint, when new or unknown IP addresses or ports are used an anomaly may be flagged for inspection by a network administrator or security specialist. Additionally, when network traffic to/from a selected VPC is outside of a predefined number of standard deviations from the average (e.g., for a given hour as merely one illustrative time frame), an anomaly may be flagged. This level of granularity is not available in the current state of the art. Further, the current state of the art is unable to perform such a level of granularity—especially across distributed cloud computing networks that span cloud networks provided by a plurality of cloud service providers—as current state of the art systems do not deploy and control VPCs and corresponding gateways. As a result, the anomaly detection provided by the topology detection system 138 as discussed herein provides a technical benefit and improvement in the field of network security.

Referring now to FIG. 6A, a graphical representation of interface screens displaying portions of a dashboard of a visualization platform directed to illustrating information pertaining to anomaly detection within network traffic of a cloud-computing environment is shown according to some embodiments. The dashboard display screen (dashboard) 600 of FIG. 6A may be an alternative embodiment of the dashboard 300 of FIG. 3A in that the dashboard 600 includes content obtained from the controller 102 and any gateways deployed thereby and any statistics or data derived or generated therefrom (where the topology system logic 138 obtains and derives or generates such data or statistics). The dashboard 600 includes a display portion 602 that includes several links (tabs), the selection of which results in display of certain data or statistics pertaining to network traffic generated by the topology system logic 138. Specifically, FIG. 6A illustrates the selection of an “anomalies” feature 604, which results in the display of content corresponding to the anomaly detection feature introduced above. When the anomalies feature 604 is selected, the dashboard 600 includes a configuration display portion (or display pane) 606 that includes an indication of a number of monitored VPCs as well as a number of VPCs in a learning phase (also referred to herein as a learning period) (left side of configuration display pane 606). Additionally, the configuration display pane 606 includes a detection sensitivity user input (UI) component that is configured to receive user input corresponding to selection of a detection sensitivity level (e.g., low, recommended, or high). Adjustment of the detection sensitivity level may refer to an adjustment of the number of standard deviations from one or more metrics of a VPC's fingerprint that are required to flag an anomaly. For example, a low sensitivity detection level may correspond to an anomaly being flagged when real-time data (one or more metrics) is at least 5 standard deviations away (+/−) from the fingerprint of a VPC, a recommend sensitivity detection level may correspond to an anomaly being flagged when real-time data (one or more metrics) is at least 3 standard deviations away from the fingerprint of a VPC, and a high sensitivity detection level may correspond to an anomaly being flagged when real-time data (one or more metrics) is at least 1 standard deviation away from the fingerprint of a VPC. However, it is noted that these are exemplary levels and may be adjusted in real-time. Further, the configuration display pane 606 includes a UI component (e.g., a toggle switch) to turn alerts on and off.

The dashboard 600 also includes a set of time filters 608 that may be adjusted via user input, where implementation of time filters may affect the displayed metrics or statistics displayed in one or more the metrics display panes 610-624, which each provide a graphical or textual representation of anomaly detection. Examples of such metrics or statistics include, but are not limited or restricted to: a number of total anomalies detected (display pane 610); VPCs with an anomaly (display pane 612); metrics with deviations (display pane 614); anomalies by deviation label (low, medium, high, etc.) (display pane 616); anomalies by VPC (display pane 618); metrics the most deviations (display pane 620); anomalies over time (display pane 622); and total anomalies over time (display pane 624).

Additionally, the dashboard 600 includes an anomaly detection pane 626 that provides a listing or other graphical/textual representation of the detected anomalies. For example, the anomaly detection pane 626 illustrates the listing of anomalies in a table format having a set of rows 628, each pertaining to an anomaly. Each row may include certain information corresponding to an anomaly such as a timestamp of a detection time, a VPC name or identifier at which the anomaly was detected, a cloud service provider of the cloud computing network in which the VPC was deployed, a number of metrics monitored for the VPC (or alternatively, a number of metrics meeting the selected sensitivity detection level), the deviation level of one or more of the metrics and optional feedback. The feedback icon 630 is shown as being selected (e.g., “a thumbs down”), which indicates negative feedback. The negative feedback may be interpreted by the topology system logic 138 as an indication that the detected anomaly should not be considered an anomaly for at least the particular VPC. The feedback may be received by the feedback icon 630 via user input. The feedback icon 630 may alternatively or in addition comprise a positive feedback option as well (which would be interpreted as confirmation of the anomaly). Received feedback may be used to tune the fingerprint in the same manner as discussed above.

Referring now to FIG. 6B, a graphical representation of an interface screen displaying data pertaining to monitored VPCs is shown according to some embodiments. The display screen 632 is shown as a “pop-up,” which may be a secondary display screen rendered as an overlay to the dashboard 600. However, in other embodiments, the display screen 632 may be integrated directly into the dashboard 600. The display screen 632 may include a listing (e.g., a table 634) of VPCs being monitored and those in a learning phase. For instance, each row of the table 6345 may pertain to a VPC and include information such as a VPC name/identifier, a cloud service provider of the cloud computing network in which the VPC is deployed, a region of the cloud computing network, a status of the learning phase of the VPC, and a detection status. The display screen 632 may be accessed by user input selecting an “edit” or “menu” UI component in the configuration display pane 606 (e.g., left side adjacent to the indication of a number of monitored VPCs as well as a number of VPCs in a learning phase).

Referring to FIG. 6C, a graphical representation of an interface screen configured to receive user input indicating instructions for managing the monitoring of designated VPCs is shown according to some embodiments. The display screen 636 is shown as a “pop-up,” in a similar manner as the display screen 632 but may also be integrated directly into the dashboard 600 in some embodiments. The display screen 636 includes content pertaining to the management of the monitoring of VPCs. For instance, the display screen 636 includes a first listing (table) 638 of all VPCs available for monitoring. The first listing 638 may include, for each VPC, a VPC name/identifier, a cloud service provider providing the cloud computing network in which the VPC is deployed and a corresponding region. A second listing (table) 640 may also be provided that includes a listing of all VPCs currently being monitored by the topology system logic 138 and may provide similar information for each VPC as the first listing 638. The display screen 636 may be configured to receive user input that indicates one or more VPCs are to be monitored. In one embodiment, a drag-and-drop UI methodology may be utilized by the display screen 636 such that a VPC from the first listing 638 may be dragged and dropped into the second listing 640 to indicate that VPC is to be monitored. However, other user input methodologies known to those having ordinary skill in the art may be utilized.

Additionally, the display screen 636 includes a UI component 642 that indicates a numerical number for the learning period (e.g., in weeks) for newly added VPCs. The UI component 642 may, in some instances, be a text box, that is configured to display the learning (e.g., 4 or “four”) and also configured to receive user input to adjust the learning period.

In the foregoing description, the invention is described with reference to specific exemplary embodiments thereof. It will, however, be evident that various modifications and changes may be made thereto without departing from the broader spirit and scope of the invention as set forth in the appended claims.

1. A distributed cloud computing system comprising:
a controller configured to deploy a first virtual private cloud (VPC) in a first cloud computing network, a first gateway in the first VPC, a second VPC in a second cloud computing network, and a second gateway in the second VPC, and wherein a first subset of a plurality of constructs are associated with the first gateway and deployed in the first cloud computing network, and a second subset of the plurality of constructs are associated with the second gateway and deployed in the second cloud computing network; and
logic, stored on non-transitory, computer-medium, that, upon execution by one or more processors, causes performance of operations including:
generating a first fingerprint for the first VPC being a statistical measure of a plurality of network metrics during a learning phase;
generating a second fingerprint for the second VPC being a statistical measure of the plurality of network metrics during the learning phase;
receiving, from the controller, metadata pertaining to each of the first gateway and the second gateway;
receiving, from each of the first gateway and the second gateway, network data, wherein the metadata and the network data identify each construct of the plurality of constructs, the communication paths between each construct of the plurality of constructs, and in which cloud computing network each construct of the plurality of constructs is deployed;
detecting an anomaly in one or more network traffic metrics of either the first VPC or the second VPC based on a comparison of received network traffic and at least one of the first and second fingerprints; and
generating an alert that the anomaly was detected.

2. The distributed cloud computing system of claim 1, wherein the logic, upon execution by the one or more processors, causes performance of further operations including:
causing rendering of a visualization on a display screen of a network device illustrating a plurality of metric display portions each providing a textual or graphical representation of a metric pertaining to anomaly detection for at least one of the first VPC, the second VPC, the first cloud computing network, or the second cloud computing network.

3. The distributed cloud computing system of claim 1, wherein the first fingerprint comprises one or more of the following: data exfiltration, lateral movement, use of ports, use of protocols, distributed denial-of-service attacks, port scan detection, and unencrypted traffic flows.

4. The distributed cloud computing system of claim 1, wherein the learning phase comprises historical network traffic data.

5. The distributed cloud computing system of claim 1, wherein the first fingerprint is generated via a supervised learning technique.

6. The distributed cloud computing system of claim 1, wherein the first fingerprint is generated via feedforward neural network model trained with historical data.

7. The distributed cloud computing system of claim 1, wherein the logic, upon execution by the one or more processors, causes performance of further operations including:
causing a rendering of a visualization comprising the first fingerprint and current behavior of at least one network metric to provide a visual indication of the anomaly.

8. The distributed cloud computing system of claim 1, wherein the logic, upon execution by the one or more processors, causes performance of further operations including:
responsive to the detection of an anomaly, taking a remediation action comprising one or more of blocking network traffic associated with the anomaly and diverging network traffic associated with the anomaly.

9. The distributed cloud computing system of claim 1, wherein the logic, upon execution by the one or more processors, causes performance of further operations including:
updating the first fingerprint on a periodic basis.

10. The distributed cloud computing system of claim 1, wherein the logic, upon execution by the one or more processors, causes performance of further operations including:
predicting future network metrics based upon the first fingerprint using machine learning.

11. A distributed cloud computing system comprising:
a controller configured to deploy a first virtual private cloud (VPC) in a first cloud computing network, and a first gateway in the first VPC; and
logic, stored on non-transitory, computer-medium, that, upon execution by one or more processors, causes performance of operations including:
generating a first fingerprint for the first VPC being a statistical measure of a plurality of network metrics during a learning phase;
receiving, from the controller, metadata pertaining to the first gateway;
receiving, from the first gateway, network data, wherein the metadata and the network data identify each construct of the plurality of constructs, the communication paths between each construct of the plurality of constructs, and in which cloud computing network each construct of the plurality of constructs is deployed;
detecting an anomaly in one or more network traffic metrics of the first VPC based on a comparison of received network traffic and the first fingerprint; and
generating an alert that the anomaly was detected.

12. The distributed cloud computing system of claim 11, wherein the logic, upon execution by the one or more processors, causes performance of further operations including:
causing rendering of a visualization on a display screen of a network device illustrating a plurality of metric display portions each providing a textual or graphical representation of a metric pertaining to anomaly detection for at least one of the first VPC and the first cloud computing network.

13. The distributed cloud computing system of claim 11, wherein the first fingerprint comprises one or more of the following: data exfiltration, lateral movement, use of ports, use of protocols, distributed denial-of-service attacks, port scan detection, and unencrypted traffic flows.

14. The distributed cloud computing system of claim 11, wherein the learning phase comprises historical network traffic data.

15. The distributed cloud computing system of claim 11, wherein the first fingerprint is generated via a supervised learning technique.

16. The distributed cloud computing system of claim 11, wherein the first fingerprint is generated via feedforward neural network model trained with historical data.

17. The distributed cloud computing system of claim 11, wherein the logic, upon execution by the one or more processors, causes performance of further operations including:
causing a rendering of a visualization comprising the first fingerprint and current behavior of at least one network metric to provide a visual indication of the anomaly.

18. The distributed cloud computing system of claim 11, wherein the logic, upon execution by the one or more processors, causes performance of further operations including:
responsive to the detection of an anomaly, taking a remediation action comprising one or more of blocking network traffic associated with the anomaly and diverging network traffic associated with the anomaly.

19. The distributed cloud computing system of claim 11, wherein the logic, upon execution by the one or more processors, causes performance of further operations including:
updating the first fingerprint on a periodic basis.

20. The distributed cloud computing system of claim 11, wherein the logic, upon execution by the one or more processors, causes performance of further operations including:
predicting future network metrics based upon the first fingerprint using machine learning.
